(19) United States
(12) Patent Application Publication
(10) Pub. No.: US 2024/0202584 A1
(43) Pub. Date: Jun. 20, 2024

(54) MACHINE LEARNING INSTANCING

(71) Applicant: Microsoft Technology Licensing, LLC, Redmond, WA (US)

(72) Inventors: Samuel Edward SCHILLACE, Portola Valley, CA (US); Umesh MADAN, Bellevue, WA (US); Brian KRABACH, Snohomish, WA (US)

(73) Assignee: Microsoft Technology Licensing, LLC, Redmond, WA (US)

(21) Appl. No.: 18/129,726

(22) Filed: Mar. 31, 2023

Related U.S. Application Data
(60) Provisional application No. 63/448,918, filed on Feb. 28, 2023.
(60) Provisional application No. 63/433,619, filed on Dec. 19, 2022.

(51) Int. Cl. G06N 20/00

(52) U.S. Cl. CPC G06N 20/00

(57) ABSTRACT

Aspects of the present disclosure relate to machine learning instancing, where an instance of an agent (e.g., including processing of user input by a machine learning model to generate model output) is encapsulated as an agent object. In examples, an agent object is stored as a file, as a document, and/or in a database, among other examples. An agent object includes a persona definition and/or an object embedding memory, thereby defining various aspects of the agent. Thus, an agent object permits portability the agent, for example between users, across contexts, and/or for a variety of subsequent processing, among other examples.

### CROSS-REFERENCE TO RELATED APPLICATION

This application claims priority to U.S. Provisional Application No. 63/448,918, titled “Machine Learning Instancing,” filed on Feb. 28, 2023, and U.S. Provisional Application No. 63/433,619, titled “Storing Entries in and Retrieving Information from an Embedding Object Memory,” filed on Dec. 19, 2022, the entire disclosures of which are hereby incorporated by reference in their entirety.

### BACKGROUND

A machine learning model may be stateless, such that the machine learning model processes subsequent user input without regard for previous interactions with the user. As a result, a user may be unable to effectively transfer their interactions with the machine learning model to another user and/or to provide such interactions for subsequent processing. Additionally, the context/knowledge available to the machine learning model may thus be limited to the input that is provided by the user, thereby resulting in reduced utility to the user.

It is with respect to these and other general considerations that aspects of the present disclosure have been described. Also, although relatively specific problems have been discussed, it should be understood that the aspects disclosed herein should not be limited to solving the specific problems identified in the background.

### SUMMARY

Aspects of the present disclosure relate to machine learning instancing, where an instance of a conversational agent (e.g., including processing of user input by a machine learning model to generate model output) is encapsulated as an agent object. In examples, an agent object is stored as a file, as a document, and/or in a database, among other examples. An agent object includes a persona definition and/or an object embedding memory, thereby defining various aspects of the agent. Thus, an agent object permits portability the conversational agent, for example between users, across contexts, and/or for a variety of subsequent processing, among other examples.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which machine learning instancing may be performed according to aspects of the present disclosure.

FIG. 2 illustrates an overview of another example system for in which machine learning instancing may be performed according to aspects described herein.

FIG. 3 illustrates an overview of an example method for providing a conversational agent based on an agent object according to aspects described herein.

FIG. 4 illustrates an overview of an example method for generating an agent according to an agent object and processing the agent object to generate an artifact according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems or devices. Accordingly, disclosed aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user interacts with a machine learning model, for example as a conversational agent that processes natural language input to generate model output accordingly. However, user interaction with the conversational agent may be limited to a conversation session, where conversation history between the user and the conversational agent is maintained and, in some examples, where at least a part of the conversation history is provided as context to the machine learning model when generating responses. However, confining machine learning model interactions to such a simple chat-based paradigm may result in reduced portability (e.g., between scenarios and/or across users) and/or may result in reduced utility to the user, among other detriments. For instance, a user may be unable to effectively export, share, or otherwise transfer their session with the conversational agent.

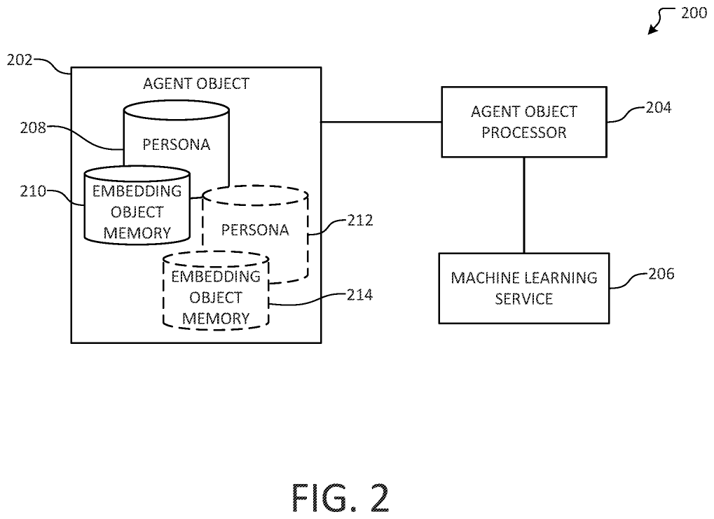

Accordingly, aspects of the present disclosure relate to machine learning instancing, where an instance of a conversational agent (e.g., including processing of user input by a machine learning model to generate model output) is encapsulated as an agent object. In examples, an agent object is stored as a file, as a document, and/or in a database, among other examples. As used herein, an agent object includes a persona definition (e.g., including one or more prompts for a machine learning model) for the agent and/or an object embedding memory, thereby defining various aspects of the agent. Additional examples of such aspects are discussed below, for example with reference to FIG. 2. Thus, an agent object permits portability the conversational agent, for example between users, across contexts, and/or for a variety of subsequent processing, among other examples.

For instance, a user interacts with a conversational agent to define aspects of its persona and/or to provide knowledge, context, or other information that is usable by the conversational agent. The instance of the conversational agent may thus be stored as an agent object (e.g., as a persona definition and/or in an object embedding memory), such that the agent object is used for subsequent processing. For example, programmatic code interrogates the agent object (e.g., using natural language and/or via an application programming interface (API)), such that the agent object is used by the programmatic code to generate model output and/or to obtain information from the corresponding embedding object memory.

As another example, the agent object is shared with other user (e.g., for collaboration and/or for subsequent use by the other user). In a further example, the agent object permits versioning, such that various versions of the agent object have different associated properties (e.g., a different persona and/or a different embedding object memory). Thus, it will be appreciated that, in some examples, an agent object enables similar semantics as are otherwise possible with a file or document (e.g., of a data store and/or of an online collaboration platform), for example saving the agent object, cloning the agent object, reverting the agent object to a previous state, creating a new version of the agent object, and/or managing permissions for the agent object (e.g., according to an access control list). As another example, one or more agent objects are used to virtualize conversational agents associated therewith, due to the portability of each conversational agent according to aspects described herein.

In examples, a persona definition and/or an embedding object memory of an agent object may be omitted and/or replaced, thereby forming a different agent object. For example, the same embedding object memory may be processed using a different agent (e.g., as is defined by a different persona definition), thereby providing the different agent access to information stored by the embedding object memory. As another example, the same persona may be used to process different, additional, or fewer embedding object memories, thereby affecting the information that is available for processing by that persona. For instance, an embedding object memory from a different agent object may be provided to an agent defined by an initial agent object. As a further example, a previous version of an embedding object memory may be restored so as to cause an agent to “forget” a period of time. As a further example, at least a part of an agent object may be used in conjunction with a different model (e.g., of a different version and/or a different type). For instance, a first persona definition of a first agent object associated with a first model may be used as a second persona definition for a second agent object that is used in conjunction with a second model. Similarly, a first embedding object memory of the first agent object may be used as a third embedding object memory for a third agent object that is used in conjunction with a third model. In instances where an existing embedding object memory is used by a different model, the embedding object memory may be transformed or otherwise ported from the previous model (e.g., with which the existing embedding object memory is associated) to the new model, such that semantic vectors of the ported embedding object memory correspond to the different model accordingly. Thus, a persona definition and/or an embedding object memory may be portable between models, thereby enabling different ML processing to be performed (e.g., according to the different model) based on a similar persona and/or memory. Any of a variety of other actions may be performed with respect to a persona definition, for example by merging personas, deduplicating personas, and/or hydrating/dehydrating personas, among other examples.

As used herein, an embedding object memory may store one or more semantic embeddings that each correspond to one or more content objects. For example, a system hosting the model may be informed by semantic context and can look into the embedding object memory (e.g., a vectorized command store) to find matching content information by semantic address and/or semantic proximity (e.g., using cosine distance or another geometric n-dimensional distance function). In some examples, content objects themselves may be partitioned, sliced, and/or sub-divided, for example to permit more fine-grained indexing and semantic proximity matching. This in turn can aid the discovery of useful overlap, similarity, and/or cross-connections (edges) with other content objects.

The embedding object memory may store embeddings associated with models and their specific versions, which may represent the same content information in different semantic embedding spaces. When a new model is added, a content object can be re-encoded (e.g., by generating a new embedding) in the new model semantic space to add to a collection of models.

In this manner, a single content object may have a locatable semantic address across models. Storing and retrieving matching content objects may require specific methodologies to ensure the content objects are available across models. The present disclosure discusses aspects of inserting entries into, retrieving information from, and rebalancing an embedding object memory.

In some examples, a hierarchy may be built of the collection of models. For example, the hierarchy may be a tree, graph, or another data structure that stores content. In some examples, not only can a content object be sub-divided into more granular pieces, but sets of related content objects (such as those related by topic, time of creation, or other properties recognized by those of ordinary skill in the art) can be aggregated. The aggregated content objects can form more general higher level layers of a data structure, such as a tree. AI models, such as those described herein, can used to create new aggregated or merged content (e.g., summary, notes, rewrites etc.) that captures higher level semantic meanings of the set below it into a single new object. The object can in turn turned into an embedding.

Some aspects of the present disclosure relate to methods, systems, and media for storing entries in an embedding object memory. Generally, one or more content items (e.g., emails, audio data, video data, messages, internet encyclopedia data, skills, commands, source code, programmatic evaluations, etc.) may be received. The one or more content items may include one or more content data (e.g., each email in the emails, each audio file in the audio data, each video file in the video data, each message in the messages, each page of the internet encyclopedia, etc.). One or more of the content data associated with the content item may be provided to one or more semantic embedding models (e.g., a generative large language model, machine-learning model, etc.) to generate one or more semantic embeddings. One or more semantic embeddings may be received from the one or more semantic embedding models. In this respect, the large quantities of information that a computing device receives may be converted to embeddings (e.g., semantic embeddings) that can be mathematically compared and that occupy a relatively smaller amount of memory than the large quantities of information themselves.

A collection of semantic embeddings may be associated with a respective semantic embedding model. For example, a first collection of embeddings may be associated with a first semantic embedding model of the one or more semantic embedding models. Further, the collection of embeddings may include a first semantic embedding generated by the first semantic embedding model for at least one content data from the respective content item. In some examples, the semantic embedding models may be optimized for specific scenarios. For example, some semantic embedding models may be configured to produce embeddings with superior results for semantic proximity on certain object types, such as emails (e.g., for a specific user and/or organization). As another example, some semantic embedding models may be configured based on specific problem types (e.g., finding documents with 3-4 word topic summaries that are relatively close based on semantic similarity). The semantic embeddings models that are optimized for specific scenarios may generate embeddings that are relatively smaller or relatively larger than other semantic embedding models that are not configured for the specific scenarios. In some examples, hints may be provided to the semantic embedding models, such as to configure the models for the specific scenarios. The hints may be provided by a user and/or by an automated system, such as to provide options or strategies related to an input provided to the models.

The one or more semantic embeddings received from the semantic embedding models may be inserted into the embedding object memory. The one or more semantic embeddings may be associated with a respective indication corresponding to a location of source data associated with the one or more semantic embeddings. Further, the insertion may trigger a spatial storage operation to store a vector representation of the one or more semantic embeddings. The vector representation may be stored in at least one of an approximate nearest neighbor (ANN) tree, a k-dimensional (k-d) tree, an octree, an n-dimensional tree, or another data structure that may be recognized by those of ordinary skill in the art at least in light of teachings described herein.

Additionally, or alternatively, some aspects of the present disclosure relate to methods, system, and media for retrieving information from an embedding object memory. Generally, an input embedding may be received that is generated by a machine-learning model. The input embedding is discussed in further detail later herein. A plurality of collections of stored embeddings may be retrieved by mechanisms described herein. The plurality of collections of embeddings may each correspond to respective content data. A subset of embeddings from at least one of the plurality of collections of stored embeddings may be retrieved based on a similarity to the input embedding. Further, an action may be determined based on the subset of embeddings and the input embedding.

In some examples, the embedding object memory may contain tuples that include the stored embeddings, such as {value, embedding} or {key, embedding}. In such examples, the key, value, or an identification of original raw content associated with an embedding may be retrieved while the embedding stays buried within the store. Therefore, the closest embeddings to an input may be found and the associated key, value, identification, and/or reference may be returned.

In some examples, original content, such as from which embeddings are generated, can be thrown away. If the embedding is generated using an auto-encoder, then given the encoding for the content (e.g., embedding), the original content can be approximately regenerated using a decoder.

Some scenarios in which an embedding itself may be retrieved could include if given a set of objects, it is desirable to create a centroid (average) that represents the set of objects in average, as well as bounding coordinates that enclose a space in which the embeddings for the set of object reside. These scenarios may be useful for object aggregation and index building.

Additional example aspects of an embedding object memory are described in U.S. Provisional Patent Application No. 63/433,619, titled “STORING ENTRIES IN AND RETRIEVING INFORMATION FROM AN EMBEDDING OBJECT MEMORY,” the entirety of which is hereby incorporated by reference for all purposes. Further, while examples are described herein with reference to an embedding object memory, it will be appreciated that any of a variety of additional or alternative information may be stored as a memory of a conversational agent, including, but not limited to, a conversation history and/or a document, among other examples.

As a result, a user may define and/or coach an agent object for any of a variety of scenarios according to aspects described herein. For example, an agent object may be created to provide customer support, for educational purposes (e.g., to teach one or more individuals about a given subject matter area), and/or for use in generating an artifact according to aspects described herein. Further, different versions of such agent objects may be used (e.g., to provide support for different versions or to teach about different subject matter areas).

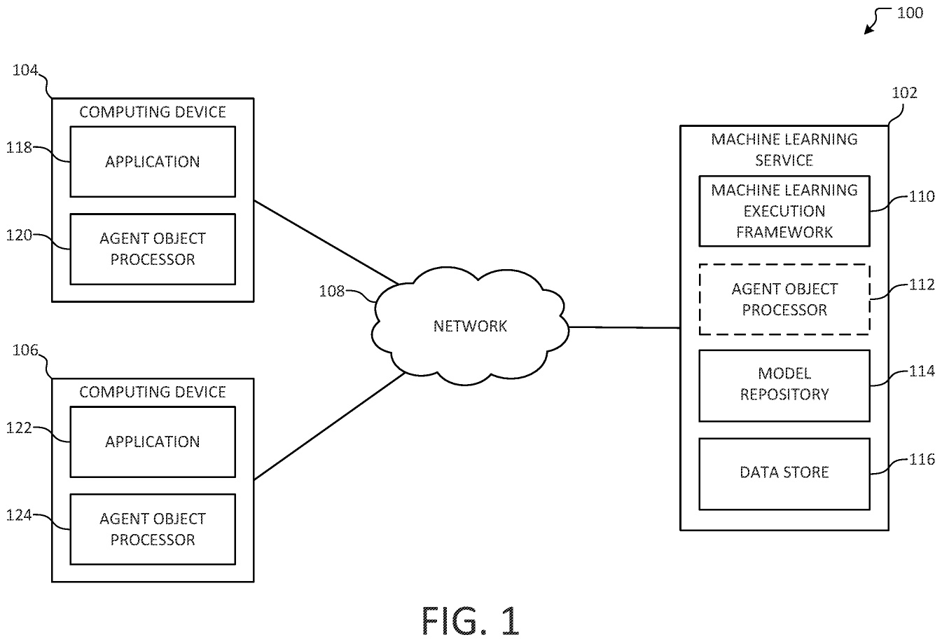

FIG. 1 illustrates an overview of an example system 100 in which machine learning instancing may be performed according to aspects of the present disclosure. As illustrated, system 100 includes machine learning service 102, computing device 104, computing device 106, and network 108. In examples, machine learning service 102, computing device 104, and/or computing device 106 communicate via network 108, which may comprise a local area network, a wireless network, or the Internet, or any combination thereof, among other examples.

As illustrated, machine learning service 102 includes machine learning execution framework 110, agent object processor 112, model repository 114, and data store 116. Agent object processor 112 is illustrated using a dashed box to indicate that, in some examples, agent object processor 112 may be omitted from machine learning service 102. For example, agent object processor 112 is included by computing device 104 and/or 106, thereby enabling local processing of an agent object according to aspects described herein. In other examples, machine learning service 102 includes agent object processor 112 while computing device 104 and/or 106 omit agent object processor 120 and/or 124, as may be the case when one or more users of computing devices 104 and/or 106 collaborate on an agent object via machine learning service 102. It will therefore be appreciated that any of a variety of paradigms are contemplated.

In examples, machine learning execution framework 110 processes user input to provide model output in response (e.g., as may be generated using a machine learning model of model repository 114), thereby providing a conversational agent with which a user of computing device 104 and/or computing device 106 may interact. While examples are described in which a user interacts with an agent, it will be appreciated that similar techniques may be used in instances where programmatic code interacts with the agent, among other examples.

For example, processing an input to generate model output for a given conversational agent (e.g., of an agent object) may comprise processing the input according to an execution chain (e.g., having one or more model skill and/or programmatic skills). As used herein, an execution chain (also referred to as a skill chain) may include one or more sequential skills, a hierarchical set of skills, a set of parallel skills, and/or a skill that is dependent on or otherwise processes output from two or more skills, among other examples.

For example, a model skill has an associated prompt template, which is used to generate a prompt (e.g., including input and/or context) that is processed using a corresponding ML model to generate model output accordingly. In other examples, an ML model associated with a model skill need not have an associated prompt template, as may be the case when prompting is not used by the ML model when processing input to generate model output. As another example, a programmatic skill may read the content of a file, obtain data from a data source and/or from a user, send an electronic message containing model output, create a file containing model output, and/or execute programmatic output that is generated by a model skill.

Thus, in instances where machine learning execution framework 110 uses an execution chain to process input, it may be possible to accomplish tasks and/or generate model output that would otherwise not have been possible via a singular ML model evaluation. For instance, information can be obtained from one or more data sources and/or input can be requested from the user while processing a skill chain, which is then used in subsequent processing (e.g., by one or more subsequent skills of the skill chain). As another example, evaluation of the skill chain may be dynamically adapted as a result of a constituent evaluation, thereby affecting one or more future evaluations of the skill chain (e.g., by adding an evaluation, removing an evaluation, or changing an evaluation). Further, the execution chain itself may be managed, orchestrated, and/or derived by an ML model (e.g., by a generative ML model based on natural language input that is received from a user and/or input that is generated by or otherwise received from an application). Additionally, given different ML models may be chained together (e.g., which may each generate a different type of model output), the resulting model output may be output that would not otherwise be produced as a result of processing by a single ML model. Additional aspects of machine learning execution framework 110 are described in U.S. Provisional Patent Application No. 63/433,627, titled “MULTI-STAGE MACHINE LEARNING MODEL CHAINING,” the entirety of which is hereby incorporated by reference for all purposes.

As another example, an agent object is provided for processing by an execution chain (e.g., by a programmatic and/or machine learning block), such that the agent object is interrogated (e.g., using one or more natural language inputs) and/or information is extracted from a memory associated therewith, among other examples. In other examples, an agent object may be used as a skill that is processed as part of an execution chain. It will be appreciated that any of a variety of alternative or additional processing may be performed using an agent object, for example by programmatic code executing on computing device 104 and/or 106.

Machine learning service 102 is further illustrated as including model repository 114, which may include any number of different machine learning models. For example, model repository 114 includes one or more foundation models, language models, speech models, video models, and/or audio models. As used herein, a foundation model is a model that is pre-trained on broad data that can be adapted to a wide range of tasks (e.g., models capable of processing various different tasks or modalities). In examples, a multimodal machine learning model of model repository 114 may have been trained using training data having a plurality of content types. Thus, given content of a first type, a model of model repository 114 may generate content having any of a variety of associated types. It will be appreciated that model repository 114 may include a foundation model as well as a model that has been finetuned (e.g., for a specific context and/or a specific user or set of users), among other examples.

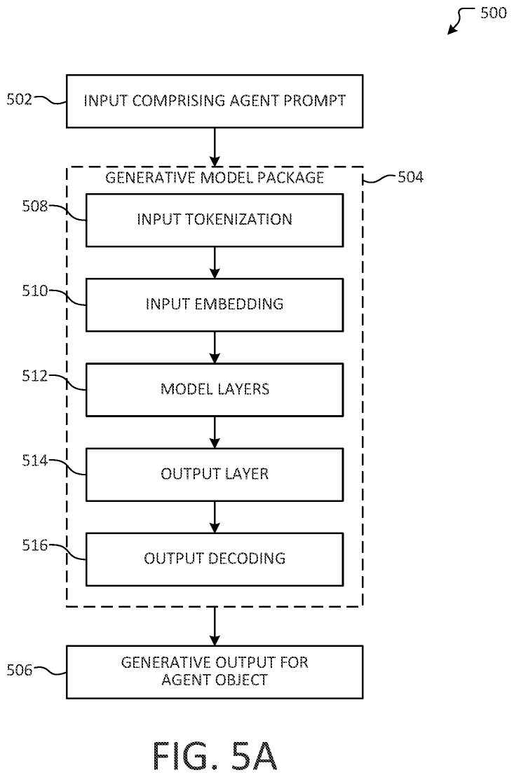

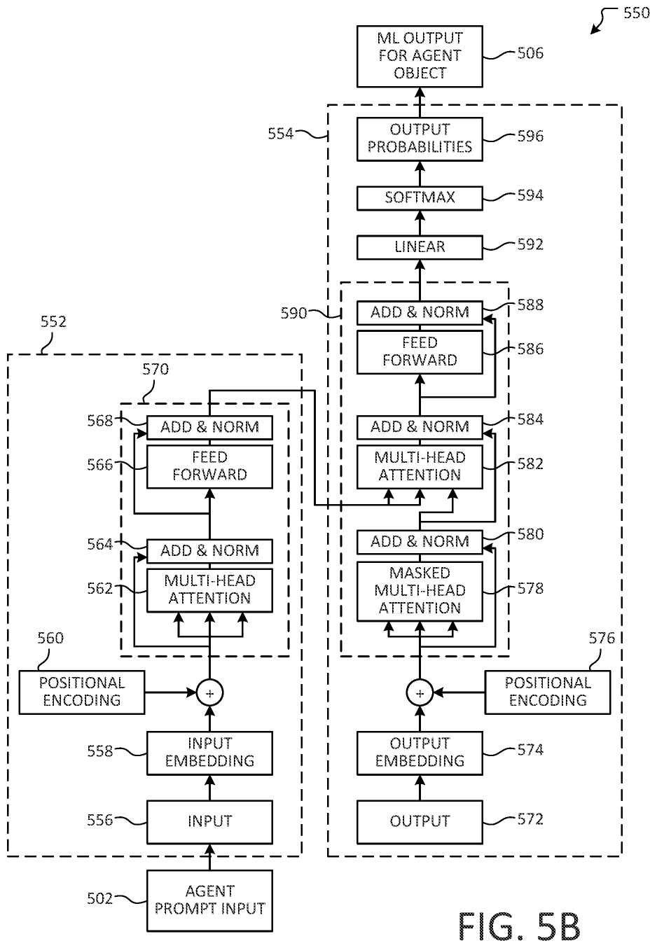

As another example, a generative model (also generally referred to herein as a type of machine learning model) used according to aspects described herein may generate any of a variety of output types (and may thus be a multimodal generative model, in some examples) and may be a generative transformer model and/or a large language model (LLM), a generative image model, in some examples. Example machine learning (ML) models include, but are not limited to, Generative Pre-trained Transformer 3 (GPT-3), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B.

System 100 is further illustrated as including data store 116, which may store one or more agent objects for subsequent retrieval (e.g., by machine learning execution framework 110, computing device 104, and/or computing device 106). Additionally, or alternatively, computing device 104 and/or 106 includes such a data store.

With reference now to computing device 104, computing device 104 further includes application 118 and agent object processor 120. In examples, application 118 receives user input and provides model output, as may be generated by an agent object processor (e.g., agent object processor 112, 120, and/or 124) according to aspects described herein. Aspects of agent object processor 120 are similar to agent object processors 112 and 124, such that agent object processors 112 and 124 are not necessarily redescribed in detail.

In examples, agent object processor 120 processes input according to an agent object to provide an instance of an agent with which a user and/or programmatic code can interact, among other examples. As noted above, a machine learning model (e.g., of model repository 114) is used to generate model output, thereby providing the instance of the agent accordingly. Agent object processor 120 processes input according to a persona and/or embedding object memory defined by the agent object to generate model output accordingly. Additional examples of such aspects are discussed below with respect to FIGS. 2, 3, and 4.

As illustrated, system 100 includes two computing devices 104 and 106, such that an agent object may be shared by a first user of computing device 104 with a second user of computing device 106. In examples, the first user sends the agent object in an electronic message, as the user may otherwise send a file or document. As another example, the first user stores the agent object at a location that is accessible by the second user (e.g., data store 116). In such an example, an access control list or other set of permissions may be defined for the agent object, which may thus grant the second user access to the agent object accordingly. As a further example, machine learning service 102 operates as a collaboration platform (or a separate collaboration platform is used), such that the first and second user are able to collaborate using the agent object via the machine learning service or collaboration platform. It will be appreciated that other examples may include any number of computing devices and/or associated users.

FIG. 2 illustrates an overview of another example system 200 for in which machine learning instancing may be performed according to aspects described herein. As illustrated, system 200 includes agent object 202, agent object processor 204, and machine learning service 206. Aspects of agent object processor 204 and machine learning service 206 may be similar to agent object processor 120 and machine learning service 102 discussed above with respect to FIG. 1 and are therefore not necessarily redescribed in detail below.

Agent object 202 is provided as an example agent object that defines aspects of a conversational agent according to aspects described herein. As illustrated, agent object 202 includes persona 208 and embedding object memory 210. Agent object 202 is further illustrated as including persona 212 and embedding object memory 214 to indicate that an agent object may include any number of personas and/or embedding object memories. Further, as noted above, different personas and/or embedding object memories may be added, removed, or substituted to yield a new version of an agent object or a different agent object, among other examples.

In examples, persona 208 includes a set of prompts that define or otherwise manage interaction by the agent. For example, persona 208 includes a description definition, an intent rewriting definition, a response generation definition, and a memory extraction definition. Aspects of persona 208 may be user-definable and/or may be hard-coded, among other examples. Further, it will be appreciated that fewer, alternative, and/or additional definitions may be used in other examples. For example, additional and/or alternative definitions may be used to define and/or emulate other aspects of metacognition and/or executive functions to yield a more complicated persona for the agent.

As an example, a description definition includes a prompt that defines a personality for the agent. An intent rewriting definition may include a prompt with which input is processed to extract an intent associated therewith. In some instances, an extracted intent is used to identify context associated with the intent, for example from embedding object memory 210. For instance, the intent is used to generate a feature vector with which one or more corresponding content objects are identified accordingly.

A response generation definition may include a prompt that is used to generate model output for a given input. In examples, the prompt further incorporates at least a part of the input, the description definition, and/or one or more content objects (e.g., as were retrieved from embedding object memory 210 according to an intent associated with the given input). In some examples, the prompt further incorporates at least a part of an interaction history with the agent. Thus, the response generation definition is used to generate a prompt with which model output is generated, where the prompt includes context that is usable by the machine learning model when generating model output.

A memory extraction definition may include a prompt that is used to evaluate input and/or corresponding model output to extract content, which may be stored for later retrieval (e.g., in an embedding object memory), thereby memorializing one or more interactions with the agent (e.g., for later retrieval based on an intent having semantic similarity to the memorialized content). In examples, the memory extraction definition specifies multiple types of memories (e.g., each of which may have an associated embedding object memory), such as short-term memories, long-term memories, and/or facts, among other examples. In some examples, the memory extraction definition includes an indication as to a format for corresponding model output, such that the machine learning model is induced to generate model output conforming to the indicated format accordingly.

In examples, an agent object includes a hierarchy of personas and/or embedding object memories. For example, a user defines persona 208, sideloads content into embedding object memory 210 (e.g., as natural language and/or as one or more embedding vectors), and converses with the agent defined by agent object 202 to effectively coach the agent about model output that should be generated therefrom. In examples, a machine learning execution framework provides such functionality that enables content to be loaded into embedding object memory 210, for example by invoking a command or as an API call, among other examples.

As an example, the user describes a book (e.g., a fictional book or a textbook), such that the agent is used to generate an artifact accordingly. Example artifacts include, but are not limited to, a word processing document, a spreadsheet, a website, and/or a presentation document, among other examples. In such an example, the user may focus on various subparts of the book when conversing with the agent, such that a corresponding hierarchy is defined within agent object 202 accordingly. Thus, when generating the artifact, machine learning processing may be performed based on one or more specific nodes of the hierarchy (e.g., that correspond to the subpart of the artifact). In examples, such nodes may be expanded (e.g., where a user engages in additional interaction with the agent), split, and/or merged, among other examples.

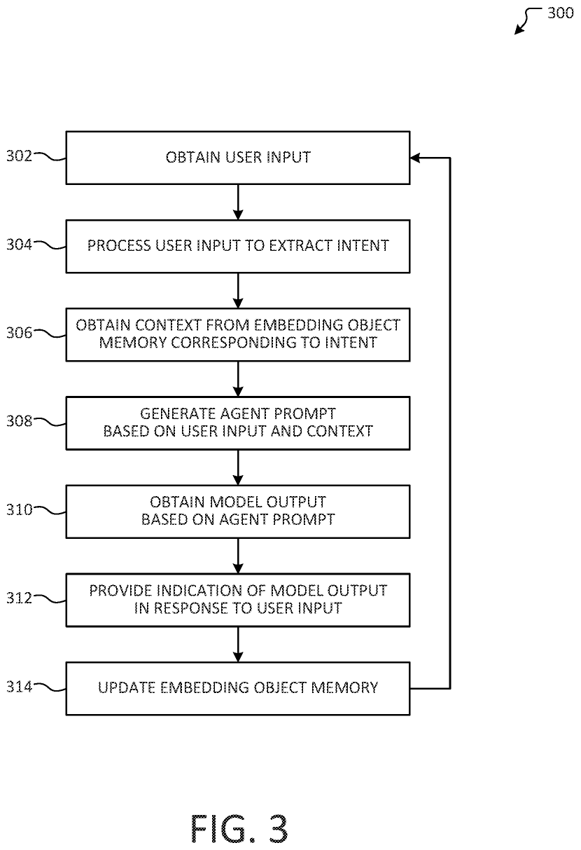

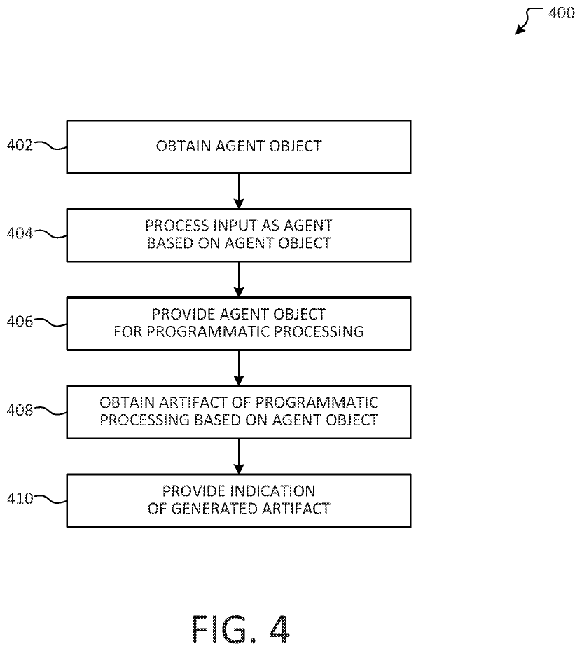

Thus, aspects of agent object 202 are processed by agent object processor 204 to yield an agent with which a user and/or programmatic code may interact, among other examples. For example, agent object processor 204 generates one or more machine learning processing requests based on persona 208/212 and/or embedding object memory 210/214, thereby causing machine learning service 206 to generate model output for a given output according to aspects described herein. Additional examples of such aspects are described below with respect to FIGS. 3 and 4.

FIG. 3 illustrates an overview of an example method 300 for providing a conversational agent based on an agent object according to aspects described herein. In examples, aspects of method 300 are performed by an agent object processor, such as agent object processor 112, 120, and/or 124 in FIG. 1 and/or agent object processor 204 in FIG. 2.

As illustrated, method 300 begins at operation 302, where user input is obtained. For example, the user input may be received via an application (e.g., application 118 and/or 122 in FIG. 1). While examples are described with respect to input from a user, it will be appreciated that similar techniques may be used for input from programmatic code and/or any of a variety of other sources. In examples, the input includes natural language input and/or any of a variety of other input.

At operation 304, the user input is processed to extract an intent. For example, the input is processed according to an intent rewriting definition of an agent object, as was described above with respect to agent object 202 in FIG. 2. In some examples, processing the input to extract the intent includes providing an indication the input with at least a part of the intent rewriting definition to a machine learning model for processing (e.g., of machine learning service 102 in FIG. 1), thereby causing the machine learning model to generate model output including an intent corresponding to the input.

Flow progresses to operation 306, where context is obtained from an embedding object memory that corresponds to the intent that was generated at operation 304. As an example, the extracted intent is used to generate a feature vector with which one or more content objects are retrieved from the embedding object memory (e.g., of an agent object). While example memory stores and associated retrieval techniques are described, it will be appreciated that any of a variety of alternative or additional memory stores and/or retrieval techniques may be used in other examples.

At operation 308, an agent prompt is generated based on the user input and the context. In examples, the agent prompt is generated based on a response generation definition of the agent object. The response generation definition may be processed to generate the agent prompt, which, as noted above, may thus include at least a part of a description definition (e.g., that defines a personality of the agent), the input, context from one or more content objects that were identified at operation 306, and/or at least a part of a conversation history for the agent, among other examples.

Moving to operation 310, model output is obtained based on the agent prompt that was generated at operation 308. Similar to operation 304, the model output may be obtained by generated a machine learning model processing request that includes the agent prompt, such that model output is received in response. The request may be provided to a machine learning service (e.g., machine learning service 102 in FIG. 1). While examples are described herein with respect to a machine learning service, it will be appreciated that similar processing may alternatively or additionally be performed local to a user's computing device.

Flow progresses to operation 312, where an indication of the model output is provided in response to the user input that was obtained at operation 302. For example, an application with which the user input was obtained may display at least a part of the model output. While method 300 is described in an example where a user converses with an agent that is defined by an agent object, it will be appreciated that model output may be provided using any of a variety of additional or alternative techniques. For example, in instances where input is obtained from programmatic code, model output may be provided in response (e.g., to a function call for machine learning processing), such that the model output may further be processed by the programmatic code accordingly.

At operation 314, an embedding object memory is updated based on the input that was obtained and/or the output that was provided. In examples, operation 314 is performed based on a memory extraction definition of the agent object, where the memory extraction definition includes a prompt that induces a machine learning model to determine one or more instances of content to memorialize. As noted above, the memory extraction definition may define one or more types of content, as may relate to short-term memories, long-term memories, and/or facts. Thus, operation 314 may include generating a machine learning processing request including the memory extraction definition and at least a part of the input and/or output, such that instances of content to memorialize are received in response accordingly. A feature vector may be generated for each content instance, such that a corresponding content object is generated within an embedding object memory for the content instance accordingly.

As illustrated, method 300 may loop between operations 302-314 to process input and generate model output according to aspects described herein. Further, as noted above, machine learning processing is used for operations 304 (e.g., to extract an intent for the input), 310 (e.g., to generate model output according to an agent object), and 314 (e.g., to memorialize various aspects of input/output for subsequent retrieval) based on various definitions provided by an agent object according to aspects described herein.

FIG. 4 illustrates an overview of an example method 400 for generating an agent according to an agent object and processing the agent object to generate an artifact according to aspects described herein. In examples, aspects of method 400 are performed by an agent object processor and/or a machine learning execution framework, among other examples.

Method 400 begins at operation 402, where an agent object is obtained. For example, the agent object may be defined by a user, obtained from a data store, obtained from another user, or from any of a variety of other sources.

At operation 404, input is processed by an object based on the obtained agent object. Examples of such aspects may be similar to method 300 discussed above with respect to FIG. 3. For example, a user may converse with the agent to tune the agents behavior and/or to provide content (e.g., as may be stored in an embedding object memory), among other examples.

Flow progresses to operation 406, where the agent object is provided for programmatic processing. For example, a reference to the agent object is provided to programmatic code, such that the agent may be interrogated and/or information may be extracted from the embedding object memory, among other examples. As another example, a document or file including the agent object is provided for processing. In some instances, the agent may itself provide the agent object for processing (e.g., a self-referential pointer, such as using a “this” variable for a class). It will therefore be appreciated that any of a variety of techniques may be used to provide the agent object for programmatic processing. Further, as noted above, any of a variety of programmatic processing may be performed, for example by an application and/or by a skill chain, among other examples.

Flow progresses to operation 408, where an artifact of the programmatic processing is obtained. As described herein, the artifact may have been generated based on the agent object, for example where the programmatic processing interrogates the agent defined by the agent object and/or extracts content from an embedding object memory associated therewith. Any of a variety of artifacts may be obtained as a result of the processing performed at operation 408.

At operation 410, an indication of the generated artifact is provided. For example, the indication may be to a user, such that the user has the option to view the generated artifact and/or operation 410 comprises providing at least a part of the artifact for display to the user. It will be appreciated that any of a variety of techniques may be used to provide an indication of the generated artifact. Further, any of a variety of additional or alternative actions may be performed based on the generated artifact in other examples.

Additionally, other examples may include requesting information from a user and/or obtaining information from a data source in addition to obtaining information from the agent defined by the agent object. For example, a user may be prompted for additional input associated with a specific subpart of the artifact or information may be obtained from a data source to supplement or otherwise clarify model output generated by the agent.

FIGS. 5A and 5B illustrate overviews of an example generative machine learning model that may be used according to aspects described herein. With reference first to FIG. 5A, conceptual diagram 500 depicts an overview of pre-trained generative model package 504 that processes an input 502 corresponding to an agent defined by an agent object to generate model output 506 for the agent according to aspects described herein. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. For example, a prompt includes a context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield output 506. For instance, each token is processed to identify a corresponding word, word fragment, or other content that forms at least a part of output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3, and 4). Accordingly, generative model package 504 operates as a tool with which machine learning processing is performed, in which certain inputs 502 to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 104 and/or 106 in FIG. 1) or may be accessed remotely from a machine learning service (e.g., machine learning service 102). In other examples, aspects of generative model package 504 are distributed across multiple computing devices. In some instances, generative model package 504 is accessible via an application programming interface (API), as may be provided by an operating system of the computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding machine learning models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input 502 corresponding to a machine learning block of an execution chain.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included. Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus use a reduced number of iterations or a single iteration.

Accordingly, output probabilities 596 may thus form ML output 506 for corresponding to an agent defined by an agent object according to aspects described herein, such that the output of the generative ML model may be provided as model output for the agent that is responsive to input to the agent accordingly.

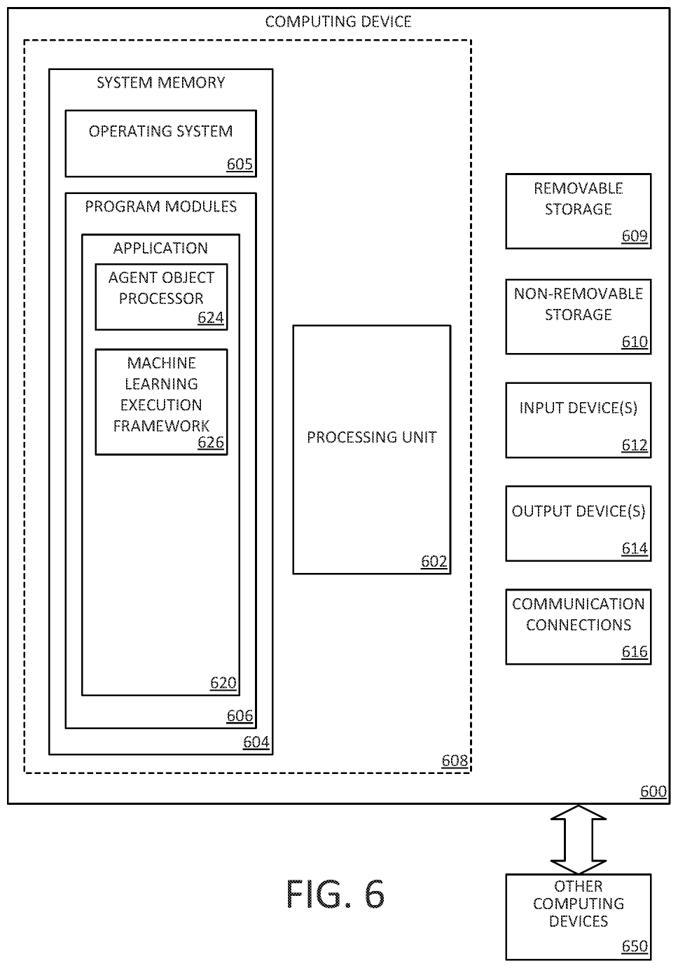

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with machine learning service 102, as well as computing device 104 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store agent object processor 624 and machine learning execution framework 626. The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

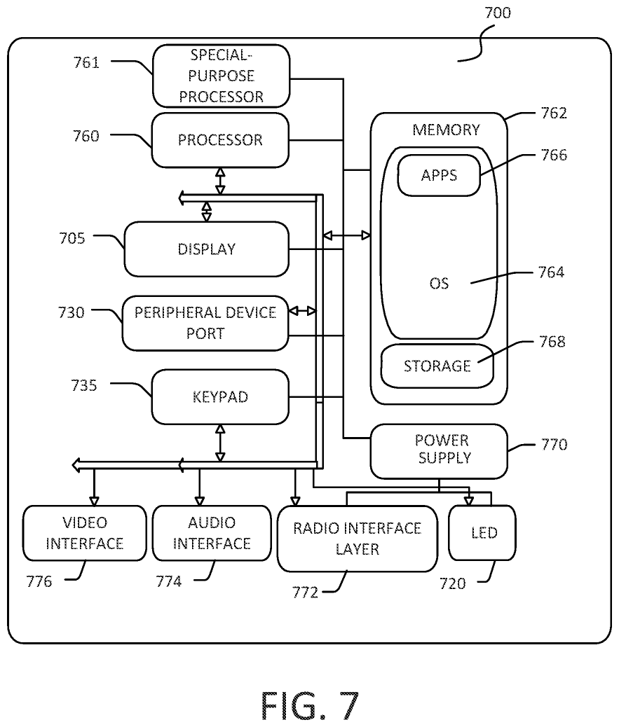

FIG. 7 illustrates a system 700 that may, for example, be a mobile computing device, such as a mobile telephone, a smart phone, wearable computer (such as a smart watch), a tablet computer, a laptop computer, and the like, with which aspects of the disclosure may be practiced. In one aspect, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some examples. In another example, an optional keypad 735 may also be included, which may be a physical keypad or a “soft” keypad generated on the touch screen display.

In various aspects, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power.

The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

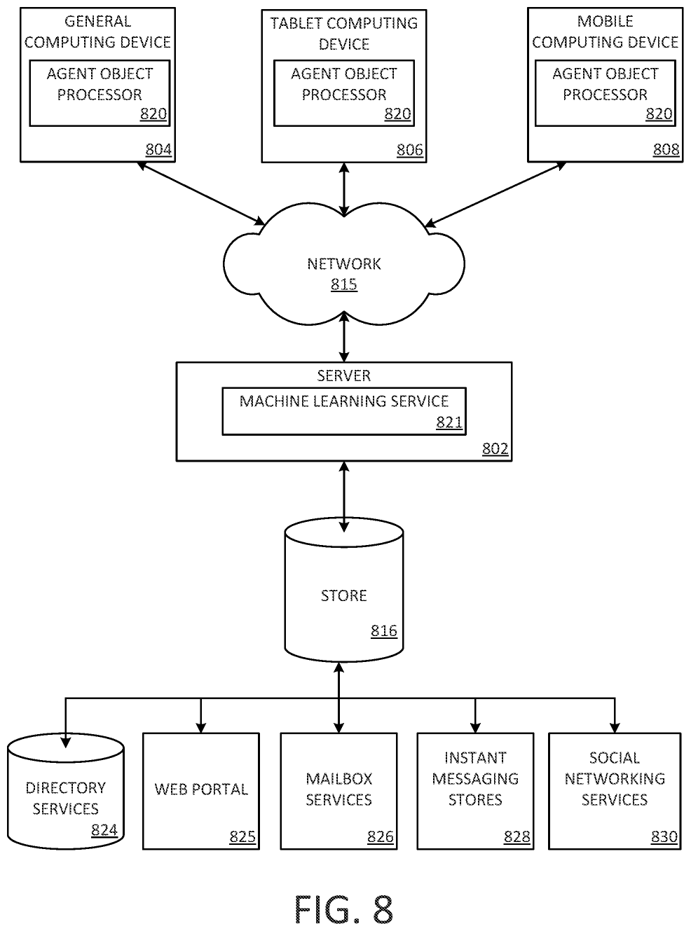

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An agent object processor 820 may be employed by a client that communicates with server device 802. Additionally, or alternatively, machine learning service 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: obtaining user input to an agent, wherein a persona of the agent is defined by an agent object; extracting an intent for the user input; determining, based on the extracted intent, context from an embedding object memory of the agent object; obtaining, based on the determined context, model output corresponding to the user input; and providing the model output in response to the obtained user input. In an example, the intent for the user input is extracted based on an intent rewriting definition of the agent object. In another example, extracting the intent comprises generating a machine learning model processing request comprising the intent rewriting definition of the agent object. In a further example, the set of operations further comprises updating the embedding object memory based on at least one of the user input or the model output. In yet another example, the embedding object memory is updated based on a memory extraction definition of the agent object. In a further still example, the persona of the agent is defined at least in part by a description definition of the agent object. In an example, obtaining the model output comprises: generating an agent prompt based on a response generation definition of the agent object; and requesting the model output based on the agent prompt; and the agent prompt includes: the description definition; the user input; the determined context; and conversation history of the agent. In another example, the agent object is a document. In a further example, the document is stored by a collaboration platform; the user input is from a first user of the collaboration platform; and user input to the agent is further received from a second user of the collaboration platform.

In another aspect, the technology relates to a method for generating an artifact based on an agent object. The method comprises: obtaining an agent object that defines a persona for an agent; receiving input to the agent; updating the agent object based on at least one of the received input or output of the agent; providing the agent object for processing by programmatic code, thereby generating an artifact based on the agent object; and providing an indication of the generated artifact. In an example, the programmatic code includes at least one of: an instruction to obtain output from the agent object based on an input; or an instruction to obtain information from an embedding object memory of the agent object. In another example, updating the agent object comprises: extracting an intent for the input; determining, based on the extracted intent, context from an embedding object memory of the agent object; obtaining, based on the determined context, model output corresponding to the user input; and updating, based on a memory extraction definition of the agent object, the embedding object memory based on at least one of the user input or the model output. In a further example, user input is requested as part of generating the artifact based on the agent object. In yet another example, the artifact is at least one of a word processing document, a spreadsheet, a website, or a presentation document.

In a further aspect, the technology relates to another method. The method comprises: obtaining user input to an agent, wherein a persona of the agent is defined by an agent object; extracting an intent for the user input; determining, based on the extracted intent, context from an embedding object memory of the agent object; obtaining, based on the determined context, model output corresponding to the user input; and providing the model output in response to the obtained user input. In an example, the method further comprises updating the embedding object memory based on at least one of the user input or the model output. In a further example, the embedding object memory is updated based on a memory extraction definition of the agent object. In yet another example, the persona of the agent is defined at least in part by a description definition of the agent object. In a further still example, obtaining the model output comprises: generating an agent prompt based on a response generation definition of the agent object; and requesting the model output based on the agent prompt; and the agent prompt includes: the description definition; the user input; the determined context; and conversation history of the agent. In another example, the agent object is a document.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspects with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining user input to an agent, wherein a persona of the agent is defined by an agent object;
extracting an intent for the user input;
determining, based on the extracted intent, context from an embedding object memory of the agent object;
obtaining, based on the determined context, model output corresponding to the user input; and
providing the model output in response to the obtained user input.

2. The system of claim 1, wherein the intent for the user input is extracted based on an intent rewriting definition of the agent object.

3. The system of claim 2, wherein extracting the intent comprises generating a machine learning model processing request comprising the intent rewriting definition of the agent object.

4. The system of claim 1, wherein the set of operations further comprises updating the embedding object memory based on at least one of the user input or the model output.

5. The system of claim 4, wherein the embedding object memory is updated based on a memory extraction definition of the agent object.

6. The system of claim 1, wherein the persona of the agent is defined at least in part by a description definition of the agent object.

7. The system of claim 6, wherein:
obtaining the model output comprises:
generating an agent prompt based on a response generation definition of the agent object; and
requesting the model output based on the agent prompt; and
the agent prompt includes:
the description definition;
the user input;
the determined context; and
conversation history of the agent.

8. The system of claim 1, wherein the agent object is a document.

9. The system of claim 8, wherein:
the document is stored by a collaboration platform;
the user input is from a first user of the collaboration platform; and
user input to the agent is further received from a second user of the collaboration platform.

10. A method for generating an artifact based on an agent object, comprising:
obtaining an agent object that defines a persona for an agent;
receiving input to the agent;
updating the agent object based on at least one of the received input or output of the agent;
providing the agent object for processing by programmatic code, thereby generating an artifact based on the agent object; and
providing an indication of the generated artifact.

11. The method of claim 10, wherein the programmatic code includes at least one of:
an instruction to obtain output from the agent object based on an input; or
an instruction to obtain information from an embedding object memory of the agent object.

12. The method of claim 10, wherein updating the agent object comprises:
extracting an intent for the input;
determining, based on the extracted intent, context from an embedding object memory of the agent object;
obtaining, based on the determined context, model output corresponding to the user input; and
updating, based on a memory extraction definition of the agent object, the embedding object memory based on at least one of the user input or the model output.

13. The method of claim 10, wherein user input is requested as part of generating the artifact based on the agent object.

14. The method of claim 10, wherein the artifact is at least one of a word processing document, a spreadsheet, a website, or a presentation document.

15. A method, comprising:
obtaining user input to an agent, wherein a persona of the agent is defined by an agent object;
extracting an intent for the user input;
determining, based on the extracted intent, context from an embedding object memory of the agent object;
obtaining, based on the determined context, model output corresponding to the user input; and
providing the model output in response to the obtained user input.

16. The method of claim 15, further comprising updating the embedding object memory based on at least one of the user input or the model output.

17. The method of claim 16, wherein the embedding object memory is updated based on a memory extraction definition of the agent object.

18. The method of claim 15, wherein the persona of the agent is defined at least in part by a description definition of the agent object.

19. The method of claim 18, wherein:
obtaining the model output comprises:
generating an agent prompt based on a response generation definition of the agent object; and
requesting the model output based on the agent prompt; and
the agent prompt includes:
the description definition;
the user input;
the determined context; and
conversation history of the agent.

20. The method of claim 15, wherein the agent object is a document.
